(19) United States
(12) Patent Application Publication
(10) Pub. No.: US 2009/0027538 A1
(43) Pub. Date: Jan. 29, 2009

(54) PROJECTOR WITH IMAGE CAPTURING ABILITY

(75) Inventor: AN-KUO LI, NEW TERRITORIES (HK)

Correspondence Address: ROSENBERG, KLEIN & LEE, 3458 ELLICOTT CENTER DRIVE-SUITE 101, ELLICOTT CITY, MD, 21043, US

(73) Assignee: TIRID TECH CO. LTD., NEW TERRITORIES (HK)

(21) Appl. No.: 11/848,728

(22) Filed: Aug. 31, 2007

(30) Foreign Application Priority Data
Jul. 27, 2007 (TW) 96212318

(51) Int. Cl. H04N 5/222

(52) U.S. Cl. 348/333.1; 348/E09.027

(57) ABSTRACT

A projector with image capturing ability is provided, which includes a portable electronic device with a detachable backlight module and a projection unit with a slot. After removing the backlight module of the portable electronic device and inserting into the slot of the projection unit, the light from a light source of the projection unit will pass through the display module and a magnification unit of the projector, and the image will be enlarged and projected on a screen so as to improve the visual quality and further to release the uncomfortableness caused by gazing at a monitor.

### BACKGROUND OF THE INVENTION

1. Field of the Invention

The present invention relates to an image player. More particularly, the present invention relates to a projector which can project and enlarge the image of a portable electronic device.

2. Description of the Prior Art

Accompanying with the progress of the science and technology, the electronic product must satisfy the demands of diversification, portability, lightness, thinness, and compactness. The current portable electronic product, such as digital camera, camcorder, Tamagotchi or the stock machine, includes a display module to show the information or image for a user. Due to the trends of the lightness, thinness, compactness, and low power consumption, most of the portable electronic products use a small-size display module to display the image. However, the small-size display module can not provide the user with a comfortable environment to enjoy watching the image, and even more, it will cause the user a uncomfortable feeling or injure the user's eyes when he/she gazes at the small-size display module.

### SUMMARY OF THE INVENTION

One object of the present invention is to provide a projector with image capturing ability. By collaborating with a portable electronic device, the projector can project and enlarge the image from the portable electronic device, wherein the portable electronic device has a detachable backlight module.

Another object of the present invention is to provide a projector with image capturing ability. After the projector enlarges and projects the image from the portable electronic device, the user will get the vivid visual effect from the big-size screen and, further, the weary feeling when he/she enjoys watching the image from the portable electronic device is reduced.

In accordance with the above objects, the present invention provides a projector with image capturing ability, and the projector includes: a shell having a side opening on a side surface of the shell; a projection unit arranged inside the shell and having a light source arranged in a backside inside the shell; and a magnification unit embedded in the side opening of the side surface; and an image capturing unit having a detachable backlight module and a display module, wherein the image capturing unit may be inserted into a slot, and the slot is positioned between the light source and the magnification unit.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram to illustrate the projector with image capturing ability in accordance with one embodiment of the present invention;

FIG. 2 is a three-dimensional diagram of the outward appearance of the projector without the image capturing unit; and

FIG. 3 is a diagram illustrating the use of the projector with the image capturing unit.

### DETAILED DESCRIPTION OF THE INVENTION

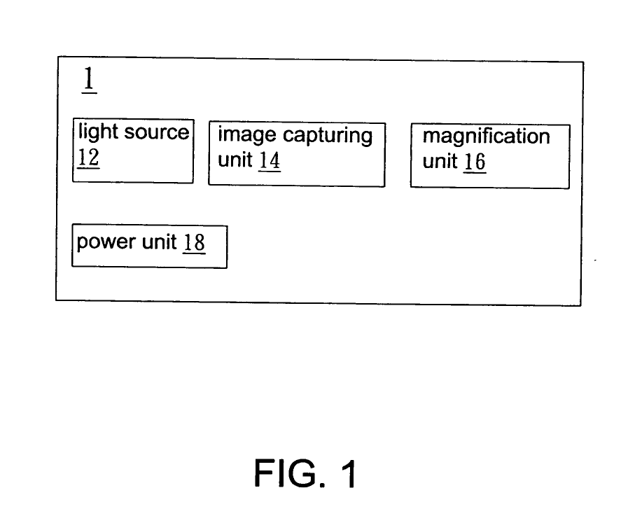

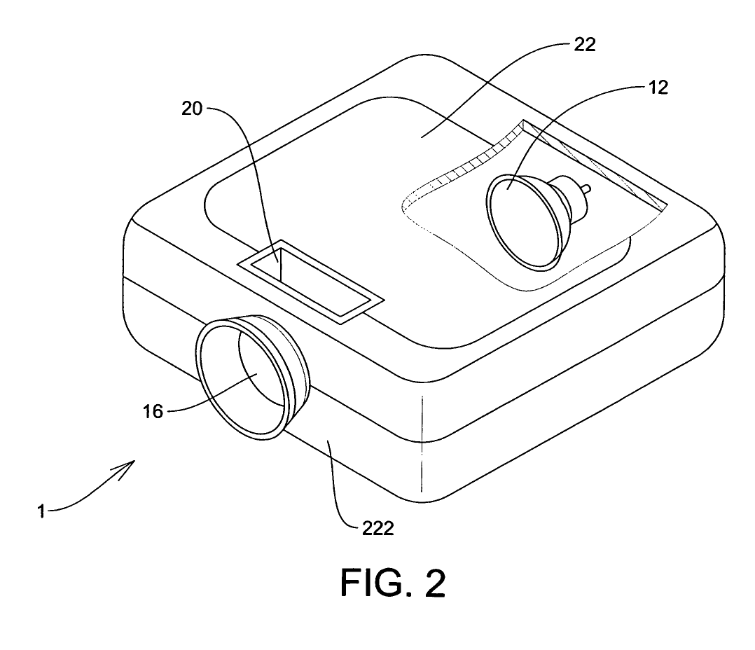

FIG. 1 is a block diagram to illustrate the projector with image capturing ability, and FIG. 2 is the three-dimensional diagram of the outward appearance of the projector without accompanying the image capturing unit in accordance with one embodiment of the present invention. The projector with image capturing ability 1 includes: a shell 22 having a side opening (not shown in the figure) on a side surface 222 of the shell 22; a projection unit arranged inside the shell 22 and having a light source 12 arranged in a backside inside the shell 22; a magnification unit 16 embedded in the side opening of the side surface 222; and an image capturing unit 14 having a detachable backlight module (not shown in the figure), wherein the image capturing unit 14 may be inserted into a slot 20 which is positioned between the light source 12 and the magnification unit 16; and a power unit 18 arranged in the shell 22 for providing the projector 1 with the necessary power.

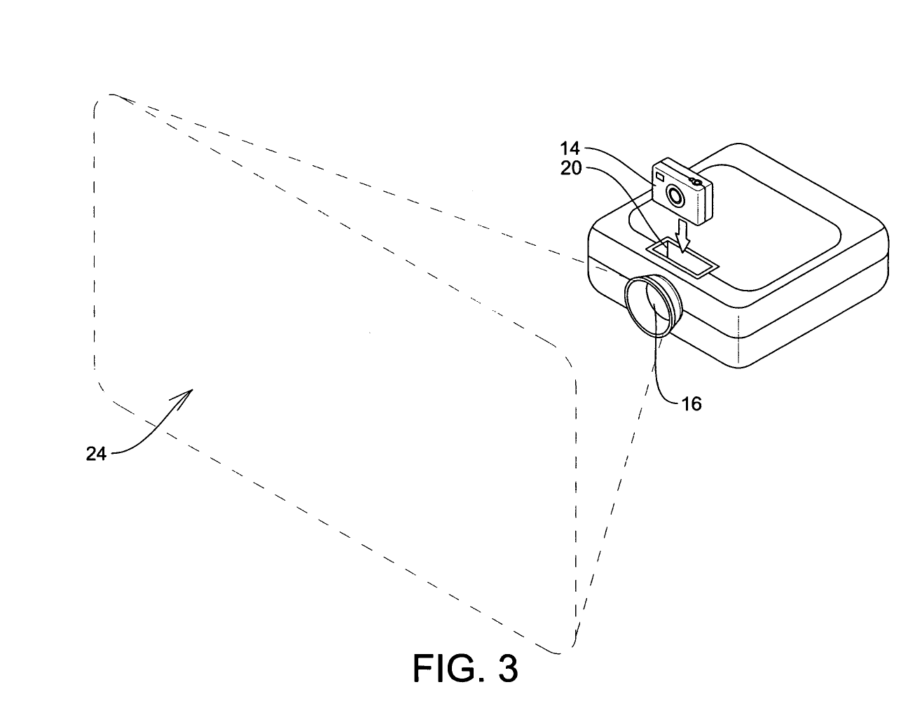

Accordingly, the image capturing unit 14 is but not limited to a portable electronic device with small-size display panel, such as digital camera, camcorder, or tomagotchi. In this embodiment, the backlight module of the image capturing unit 14 is detachable. When a user uses only the image capturing unit 14, the image capturing unit 14 is accompanied by the backlight module for immediate reviewing. It is to be understood, when the user desirees to enjoy the sight of the big-size image by projecting the image from the image capturing unit 14, he/she only needs to detach the backlight module and insert the image capturing unit 14 into the slot 20 of the projector 1. As shown in FIG. 3, after the backlight module is detached, light will penetrate the display module of the image capturing unit 14, wherein the display module is light penetrable. Since the image capturing unit 14 is inserted into the slot 20 between the light source 12 and the magnification unit 16, such as a lens, the light from the light source 12 will penetrate the display module when the user turns on the projector with image capturing ability 1, and the projector will project and enlarge the image on the display module of the image capturing unit 14 to an external screen or a wall to form a big-size image 24.

To sum up the foregoing descriptions, a projector in accordance with the present invention includes a portable electronic device which has a detachable backlight module, and a projection unit which has a slot to accommodate the portable electronic device. After detaching the backlight module and inserting the portable electronic device into the slot of the projector, the light from a light source of the projection unit will pass through the display module of the portable electronic device and the magnification unit, and the image will be enlarged and projected on a screen so as to improve the visual quality and further to release the uncomfortableness caused by gazing at a monitor.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. A projector with image capturing ability, comprising:
a shell comprising a side opening on a side surface of said shell;
a projection unit, arranged inside said shell and comprising:
a light source arranged in a backside inside said shell; and
a magnification unit embedded in said side opening of said side surface; and
an image capturing unit comprising a detachable backlight module and a display module, wherein said image capturing unit is inserted into a slot between said light source and said magnification unit.

2. The projector with image capturing ability according to claim 1, wherein said display module is light penetrable.

3. The projector with image capturing ability according to claim 1, wherein said image capturing unit is a portable electronic device.

4. The projector with image capturing ability according to claim 3, wherein said portable electronic device includes a camera.

5. The projector with image capturing ability according to claim 3, wherein said portable electronic device includes a camcorder.

6. The projector with image capturing ability according to claim 3, wherein said portable electronic device includes a tomagotchi.

7. The projector with image capturing ability according to claim 1, wherein said magnification unit includes a lens.

8. The projector with image capturing ability according to claim 1, further comprising a power unit for providing said projector with the power.
